(19) United States
(12) Patent Application Publication
(10) Pub. No.: US 2026/0231926 A1
(43) Pub. Date: Aug. 13, 2026

(54) PEST REPELLANT PUTTY DEVICE

(71) Applicant: Caleb Justice, Terre Haute, IN (US)

(72) Inventor: Caleb Justice, Terre Haute, IN (US)

(21) Appl. No.: 19/244,236

(22) Filed: Jun. 20, 2025

Related U.S. Application Data
(60) Provisional application No. 63/757,880, filed on Feb. 13, 2025.

(51) Int. Cl. A01M 29/34; A01M 29/12; A01N 25/08; A01N 59/16; A01N 65/22; A01N 65/38; A01P 17/00

(52) U.S. Cl. CPC A01M 29/34; A01M 29/12; A01N 25/08; A01N 59/16; A01N 65/22; A01N 65/38; A01P 17/00

(57) ABSTRACT

A pest repellant putty device is disclosed, which is a rolled mixture of ingredients designed to function as a nontoxic, food grade pest repellant. The pest repellant putty device comprises a body component that is configured as a putty material that can be stretched and applied to the area. Multiple nontoxic ingredients are utilized, such as cayenne pepper, peppermint extract, and chopped steel wool, and applied to mounting putty. The ingredients are kneaded together and the putty can be placed in holes or crevasses where pests may be located in order to repel them from homes, garages, and other specified areas.

### CROSS REFERENCE TO RELATED APPLICATION

The present application claims priority to, and the benefit of, U.S. Provisional Application No. 63/757,880, which was filed on Feb. 13, 2025, and is incorporated herein by reference in its entirety.

### FIELD OF THE INVENTION

The present invention relates generally to the field of pest repellant putty devices. More specifically, the present invention relates to a food grade, nontoxic pest repellant that can be applied to virtually any indoor or outdoor area. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in pest repellant putty devices. Generally, pests and animals entering areas like a home, garage, etc., can cause significant damage. Thus, homeowners may opt to use traps or chemical repellants to ward off animals. However, some products can be harmful to children and pets if they accidentally trigger a trap or get into the chemicals.

Accordingly, there is a demand for an improved pest repellant putty device that utilizes human and pet safe ingredients that ward off a large variety of insects and pests. More particularly, there is a demand for a pest repellant putty device that features a putty-like material that can be stretched and applied to a designated area, allowing the nontoxic repellant to permeate the air and ward off pests.

Therefore, there exists a long felt need in the art for a pest repellant putty device that provides users with a food grade, nontoxic pest repellant that can be applied to virtually any indoor or outdoor area. There is also a long felt need in the art for a pest repellant putty device that utilizes human and pet safe ingredients that ward off a large variety of insects and pests. Further, there is a long felt need in the art for a pest repellant putty device that features a roll of putty-like material that can be stretched and applied to the area, allowing the nontoxic repellant to permeate the air and ward off pests. Moreover, there is a long felt need in the art for a device that offers a more convenient repellant device compared to existing products. Further, there is a long felt need in the art for a pest repellant putty device that applies nontoxic, food grade ingredients to a putty-like material. Finally, there is a long felt need in the art for a pest repellant putty device that includes multiple ingredients, such as cayenne pepper, peppermint extract, and chopped steel wool.

The subject matter disclosed and claimed herein, in one embodiment thereof, comprises a pest repellant putty device. The device is a rolled mixture of ingredients designed to function as a nontoxic, food grade pest repellant. The pest repellant putty device comprises a body component that is configured as a putty material that can be stretched and applied to the area. Multiple nontoxic ingredients are utilized, such as cayenne pepper, peppermint extract, and chopped steel wool, and applied to mounting putty. The ingredients are kneaded together and the putty can be placed in holes or crevasses where pests may be located in order to repel them from homes, garages, and other specified areas.

In this manner, the pest repellant putty device of the present invention accomplishes all of the forgoing objectives and provides users with a nontoxic pest repellant. The device is a putty which is applied to holes or crevasses where pests may be located. The device offers a more convenient repellant device compared to existing products.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pest repellant putty device. The device is a rolled mixture of ingredients designed to function as a nontoxic, food grade pest repellant. The pest repellant putty device comprises a body component that is configured as a putty material that can be stretched and applied to the designated area. Multiple nontoxic ingredients are utilized and kneaded together into the putty material.

In one embodiment, the pest repellant putty device utilizes human and pet safe ingredients to ward off a large variety of insects and pests. The device provides users with a food grade, nontoxic pest repellant that can be applied to virtually any indoor or outdoor area. The pest repellant putty device offers a more convenient repellant device compared to existing products.

In one embodiment, the pest repellant putty device is a rolled mixture of ingredients designed to function as a nontoxic, food grade pest repellant. Specifically, the pest repellant putty device features a roll of putty-like material that can be stretched and applied to the area, allowing the nontoxic repellant to permeate the air and ward off pests. The pest repellant putty device can be applied to multiple surfaces, such as but not limited to, vehicle window seams, door jams, door and window seams, around a sink or backsplash, bathtub or shower seams, etc., or any other suitable indoor or outdoor area as is known in the art.

In one embodiment, the pest repellant putty device comprises a body component that is configured as a putty material that can be stretched and applied to the designated area. The body component is a putty material and so is a malleable material that can be stretched, rolled, and kneaded, etc. The body component can be any suitable shape and size as is known in the art and can be rolled, stretched, or kneaded, etc., into any desired shape and size as is known in the art to fit into the designated space(s), as desired.

In one embodiment, multiple nontoxic ingredients are utilized and kneaded into the putty material. Any suitable nontoxic, food-grade pest repellant ingredients can be utilized as is known in the art, such as cayenne pepper, peppermint extract, and chopped steel wool, etc. These ingredients are then applied to the body component putty material. Typically, the ingredients are kneaded together into the putty material but can be added in via any suitable means as is known in the art.

In one embodiment, the ingredients include approximately 1/4 teaspoon of cayenne pepper added to every 2 oz. of putty material; approximately three drops of peppermint extract added to every 0.5 oz. of putty material; and approximately ½-1 teaspoon of chopped steel wool added to every 0.5 oz. of putty material. Once these ingredients are added to the putty material, the body component putty material can then be kneaded, rolled, and/or stretched to the desired area to ward off pests safely.

In one embodiment, the body component putty material can be placed in holes or crevasses where pests may be located in order to repel them from homes, garages, vehicles, and other specified areas.

In yet another embodiment, the pest repellant putty device comprises a plurality of indicia.

In yet another embodiment, a method of repelling pests with a nontoxic material is disclosed. The method includes the steps of providing a body component which is a putty. The method also comprises adding nontoxic ingredients to a putty material. Further, the method comprises kneading the ingredients together. The method also comprises stretching and applying the body component to specified areas. Finally, the method comprises repelling pests via allowing the nontoxic repellant to permeate the air and ward off pests.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the pest repellant putty device of the present invention applied to a vehicle in accordance with the disclosed architecture;

FIG. 2 illustrates a perspective view of one embodiment of the pest repellant putty device of the present invention showing the putty mixture in accordance with the disclosed architecture;

FIG. 3 illustrates a perspective view of one embodiment of the pest repellant putty device of the present invention showing various sizes of the putty mixture in accordance with the disclosed architecture;

FIG. 4 illustrates a perspective view of one embodiment of the pest repellant putty device of the present invention showing the device in use in accordance with the disclosed architecture;

FIG. 5 illustrates a perspective view of one embodiment of the pest repellant putty device of the present invention showing the device in use to repel rodents in accordance with the disclosed architecture; and

FIG. 6 illustrates a flowchart showing the method of repelling pests with a nontoxic material in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a pest repellant putty device that provides users with a food grade, nontoxic pest repellant that can be applied to virtually any indoor or outdoor area. There is also a long felt need in the art for a pest repellant putty device that utilizes human and pet safe ingredients that ward off a large variety of insects and pests. Further, there is a long felt need in the art for a pest repellant putty device that features a roll of putty-like material that can be stretched and applied to the area, allowing the nontoxic repellant to permeate the air and ward off pests. Moreover, there is a long felt need in the art for a device that offers a more convenient repellant device compared to existing products. Further, there is a long felt need in the art for a pest repellant putty device that applies nontoxic, food grade ingredients to a putty-like material. Finally, there is a long felt need in the art for a pest repellant putty device that includes multiple ingredients, such as cayenne pepper, peppermint extract, and chopped steel wool.

The present invention, in one exemplary embodiment, is a novel pest repellant putty device. The pest repellant putty device comprises a body component that is configured as a putty material that can be stretched and applied to the area. Multiple nontoxic ingredients are utilized, such as cayenne pepper, peppermint extract, and chopped steel wool, and applied to mounting putty. The ingredients are kneaded together and the putty can be placed in holes or crevasses where pests may be located in order to repel them from homes, garages, and other specified areas. The present invention also includes a novel method of repelling pests with a nontoxic material. The method includes the steps of providing a body component which is a putty. The method also comprises adding nontoxic ingredients to a putty material. Further, the method comprises kneading the ingredients together. The method also comprises stretching and applying the body component to specified areas. Finally, the method comprises repelling pests via allowing the nontoxic repellant to permeate the air and ward off pests.

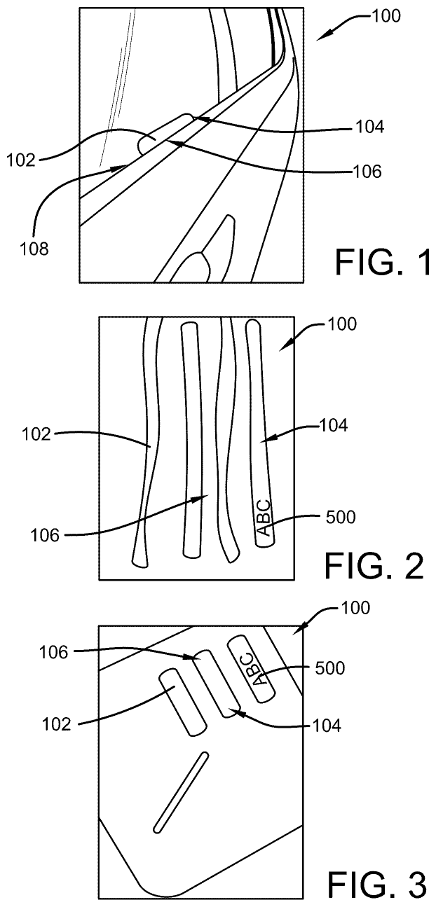

Referring initially to the drawings, FIG. 1 illustrate a perspective view of one embodiment of the pest repellant putty device 100 of the present invention. In the present embodiment, the pest repellant putty device 100 is an improved pest repellant putty device 100 that provides a user with a nontoxic food-grade pest repellant. Specifically, the pest repellant putty device 100 comprises a body component 102 which is a putty material 104 that can be stretched and applied to a designated area. Multiple nontoxic ingredients 106 are utilized and kneaded together into the putty material 104.

Generally, the pest repellant putty device 100 utilizes human and pet safe ingredients 106 to ward off a large variety of insects and pests. The device 100 provides users with a food grade, nontoxic pest repellant that can be applied to virtually any indoor or outdoor area. The pest repellant putty device 100 offers a more convenient repellant device 100 compared to existing products.

Further, the pest repellant putty device 100 is a rolled mixture of ingredients 106 designed to function as a nontoxic, food grade pest repellant. Specifically, the pest repellant putty device 100 features a roll of putty-like material 104 that can be stretched and applied to the area, allowing the nontoxic repellant to permeate the air and ward off pests. The pest repellant putty device 100 can be applied to multiple surfaces, such as but not limited to, vehicle window seams 108, door jams, door and window seams, around a sink or backsplash, bathtub or shower seams, etc., or any other suitable indoor or outdoor area as is known in the art.

Additionally, the pest repellant putty device 100 comprises a body component 102 that is configured as a putty material 104 that can be stretched and applied to the designated area. The body component 102 is a putty material 104 and so is a malleable material that can be stretched, rolled, and kneaded, etc. The body component 102 can be any suitable shape and size as is known in the art and can be rolled, stretched, or kneaded, etc., into any desired shape and size as is known in the art to fit into the designated space(s), as desired.

As shown in FIGS. 2-3, multiple nontoxic ingredients 106 are utilized and kneaded into the putty material 104. Any suitable nontoxic, food-grade pest repellant ingredients 106 can be utilized as is known in the art, such as cayenne pepper, peppermint extract, and chopped steel wool, etc. These ingredients 106 are then applied to the body component 102 putty material 104. Typically, the ingredients 106 are kneaded together into the putty material 104 but can be added in via any suitable means as is known in the art.

In one embodiment, the ingredients 106 include approximately 1/4 teaspoon of cayenne pepper added to every 2 oz. of putty material 104; approximately three drops of peppermint extract added to every 0.5 oz. of putty material 104; and approximately ½-1 teaspoon of chopped steel wool added to every 0.5 oz. of putty material 104. Once these ingredients 106 are added to the putty material 104, the body component 102 putty material 104 can then be kneaded, rolled, and/or stretched to the desired area to ward off pests safely. However, other variations of the same ingredients 106 can be utilized and added to the putty material 104 in the same way, such as but not limited to: putty material 104 with cayenne pepper, peppermint extract, and chopped steel wool; or putty material 104 with cayenne pepper and peppermint extract; or putty material 104 with cayenne pepper; or putty material 104 with peppermint extract; or putty material 104 with chopped steel wool, etc.

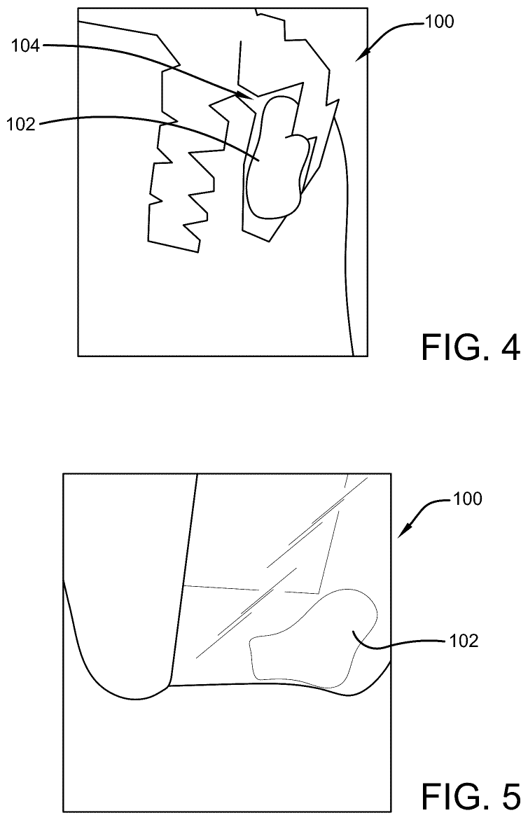

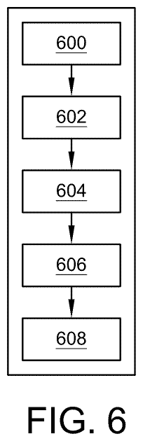

As shown in FIGS. 4-5, the body component 102 putty material 104 can be placed in holes or crevasses where pests may be located in order to repel them from homes, garages, vehicles, and other specified areas.

In yet another embodiment, the pest repellant putty device 100 comprises a plurality of indicia 500. The body component 102 of the device 100 may include advertising, a trademark, or other letters, designs, or characters, printed, painted, stamped, or integrated into the body component 102, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be pest, repellant, or brand related.

FIG. 6 illustrates a flowchart of the method of repelling pests with a nontoxic material. The method includes the steps of at 600, providing a body component which is a putty. The method also comprises at 602, adding nontoxic ingredients to a putty material. Further, the method comprises at 604, kneading the ingredients together. The method also comprises at 606, stretching and applying the body component to specified areas. Finally, the method comprises at 608, repelling pests via allowing the nontoxic repellant to permeate the air and ward off pests.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “pest repellant putty device”, “pest repellant device”, “putty device”, and “device” are interchangeable and refer to the pest repellant putty device 100 of the present invention.

Notwithstanding the forgoing, the pest repellant putty device 100 of the present invention can be of any suitable size and configuration as is known in the art without affecting the overall concept of the invention, provided that it accomplishes the above stated objectives. One of ordinary skill in the art will appreciate that the pest repellant putty device 100 as shown in FIGS. 1-6 is for illustrative purposes only, and that many other sizes and shapes of the pest repellant putty device 100 are well within the scope of the present disclosure. Although the dimensions of the pest repellant putty device 100 are important design parameters for user convenience, the pest repellant putty device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pest repellant putty device that provides a user with a nontoxic food-grade pest repellant, the pest repellant putty device comprising:
a body component; and
a plurality of nontoxic ingredients;
wherein the body component is a putty material that can be stretched and applied to a designated area;
wherein the plurality of nontoxic ingredients are utilized and kneaded together in the putty material; and
further wherein the body component is stretched and applied to a suitable indoor or outdoor area to ward off a large variety of pests and insects.

2. The pest repellant putty device of claim 1, wherein the body component is comprised of a rolled mixture of ingredients kneaded into the putty material.

3. The pest repellant putty device of claim 2, wherein the plurality of nontoxic ingredients are configured to permeate the air and ward off pests.

4. The pest repellant putty device of claim 3, wherein the body component can be applied to any suitable indoor or outdoor area, such as vehicle window seams, door jams, door and window seams, around a sink or backsplash, and bathtub or shower seams.

5. The pest repellant putty device of claim 4, wherein the putty material of the body component is configured to be a malleable material that can be stretched, rolled and kneaded.

6. The pest repellant putty device of claim 5, wherein the body component can be any suitable shape and size as is known in the art and can fit into any designated space desired.

7. The pest repellant putty device of claim 6, wherein the plurality of nontoxic ingredients are comprised of a cayenne pepper, a peppermint extract, and a chopped steel wool.

8. The pest repellant putty device of claim 7, wherein the plurality of nontoxic ingredients include approximately ¼ teaspoon of the cayenne pepper added to every 2 oz. of the putty material;
approximately three drops of the peppermint extract added to every 0.5 oz. of the putty material;
and approximately ½-1 teaspoon of the chopped steel wool added to every 0.5 oz. of the putty material.

9. The pest repellant putty device of claim 8, wherein the body component is placed in holes or crevasses where pests may be located in order to repel them from homes, garages, and vehicles.

10. The pest repellant putty device of claim 9 further comprising a plurality of indicia.

11. A pest repellant putty device that provides a user with a nontoxic food-grade pest repellant, the pest repellant putty device comprising:
a body component; and
a plurality of nontoxic ingredients comprised of a cayenne pepper, a peppermint extract and a chopped steel wool;
wherein the body component is a putty material that can be stretched and applied to a designated area; and
further wherein the plurality of nontoxic ingredients are utilized and kneaded together in the putty material.

12. The pest repellant putty device of claim 11, wherein the plurality of nontoxic ingredients include approximately ¼ teaspoon of the cayenne pepper added to every 2 oz. of the putty material;
approximately three drops of the peppermint extract added to every 0.5 oz. of the putty material;
and approximately ½-1 teaspoon of the chopped steel wool added to every 0.5 oz. of the putty material.

13. The pest repellant putty device of claim 11, wherein the body component can be any suitable shape and size as is known in the art and can fit into any designated space desired.

14. The pest repellant putty device of claim 11, wherein the body component is configured to be applied to any suitable indoor or outdoor area, such as vehicle window seams, door jams, door and window seams, around a sink or backsplash, and bathtub or shower seams.

15. The pest repellant putty device of claim 11, wherein the body component is comprised of a rolled mixture of ingredients kneaded into the putty material.

16. The pest repellant putty device of claim 11, wherein the putty material of the body component is a malleable material that can be stretched, rolled and kneaded.

17. The pest repellant putty device of claim 16, wherein the body component is stretched and applied to a designated area, allowing the plurality of nontoxic ingredients to permeate the air and ward off pests.

18. The pest repellant putty device of claim 17, wherein the body component is placed in holes or crevasses where pests may be located in order to repel them from homes, garages, and vehicles.

19. The pest repellant putty device of claim 11 further comprising a plurality of indicia.

20. A method of repelling pests with a nontoxic material, the method comprising the following steps:
providing a body component which is comprised of a putty material;
adding a plurality of nontoxic ingredients to the putty material;
kneading the plurality of nontoxic ingredients together;
stretching and applying the body component to a specified area; and
repelling pests via allowing the plurality of nontoxic ingredients to permeate the air and ward off pests in the specified area.
